(19) United States
(12) Patent Application Publication
(10) Pub. No.: US 2025/0153560 A1
(43) Pub. Date: May 15, 2025

(54) STORAGE TANK FIXING ASSEMBLY AND METHOD FOR CONTROLLING THE SAME

(71) Applicants: Hyundai Motor Company, Seoul (KR); Kia Corporation, Seoul (KR)

(72) Inventor: Myeong Seok Kim, Hwaseong (KR)

(21) Appl. No.: 18/904,650

(22) Filed: Oct. 2, 2024

(30) Foreign Application Priority Data
Nov. 10, 2023 (KR) 10-2023-0155740

(51) Int. Cl. B60K 15/067; F16F 15/00; F16F 15/02

(52) U.S. Cl. CPC B60K 15/067; F16F 15/002; F16F 15/022; F16F 2228/066; F16F 2230/0047; F16F 2230/18

(57) ABSTRACT

Disclosed is a storage tank fixing assembly. The storage tank fixing assembly includes a fixing frame connected to a vehicle body frame and extending in one direction, a support bracket that supports a storage tank such that the storage tank is slid in one direction with respect to the fixing frame, and a damping member that adjusts a relative movement of the support bracket with respect to the fixing frame in the one direction.

### CROSS-REFERENCE TO RELATED APPLICATION

This application claims the benefit of Korean Patent Application No. 10-2023-0155740, filed in the Korean Intellectual Property Office on Nov. 10, 2023, the entire contents of which are incorporated herein by reference.

### BACKGROUND

### Technical Field

The present disclosure relates to a storage tank fixing assembly and a method for controlling the same.

### Background

Recently, as awareness of the crisis over the environment and depletion of oil resources has increased, research and development on electric vehicles, which are eco-friendly vehicles, have been highlighted. Electric vehicles include plug-in hybrid electric vehicles (PHEVs), battery electric vehicles (BEVs), and fuel cell electric vehicles (FCEVs).

The hydrogen battery vehicle (FCEV) includes a fuel cell stack that generates electricity by using hydrogen, a storage tank that stores hydrogen, and a battery pack that stores electrical energy that is generated through regenerative braking.

Hydrogen battery vehicles essentially require a large-capacity storage tank to increase their range. To ensure a long range for the hydrogen battery vehicle, the storage tank has a cylindrical shape that extends along the widthwise direction of the vehicle.

Meanwhile, hydrogen battery vehicles can be classified into two structures based on how the storage tank is fixed in the vehicle: a neck mounting structure, which supports nozzles located at opposite ends in the lengthwise direction, and a valley mounting structure, which supports the body part. There may be a risk of damage to the hydrogen battery vehicle due to vibration from the road surface and twisting of the vehicle body frame. Therefore, the need for a structure assembly that is more stable against vibration from the road surface or twisting of the vehicle body frame while preventing damage to the hydrogen battery vehicle is increasing.

### SUMMARY

The present disclosure has been made to solve the above-mentioned problems occurring in the prior art while advantages achieved by the prior art are maintained intact.

An embodiment of the present disclosure provides a storage tank fixing assembly and a method for controlling the same, by which a degree of freedom for a fixing frame of a storage tank may be adjusted depending on situations.

An embodiment of the present disclosure also provides a storage tank fixing assembly and a method for controlling the same, by which a relative movement of a storage tank with respect to a fixing frame according to a neck mount structure of the storage tank may be adjusted.

An embodiment of the present disclosure also provides a storage tank fixing assembly and a method for controlling the same, by which a relative movement of a storage tank with respect to a fixing frame according to the valley mount structure of the storage tank may be adjusted.

The technical problems to be solved by the present disclosure are not limited to the aforementioned problems, and any other technical problems not mentioned herein will be clearly understood from the following description by those skilled in the art to which the present disclosure pertains.

According to an embodiment of the present disclosure, a storage tank fixing assembly includes a fixing frame connected to a vehicle body frame and extending in one direction, a support bracket that supports a storage tank such that the storage tank is slid in the one direction with respect to the fixing frame, and a damping member that adjusts a relative movement of the support bracket with respect to the fixing frame in the one direction.

The damping member may be configured to allow the relative movement of the support bracket with respect to the fixing frame in the one direction more freely based on that a displacement of the vehicle body frame in the one direction is greater than or equal to a preset value.

The damping member may include a damper provided between one end connected to the fixing frame and an opposite end connected to the support bracket, and a coil spring extending to surround the damper.

The storage tank fixing assembly may further include a displacement detecting sensor that detects the displacement of the vehicle body frame in the one direction.

The damping member may include a first mode, and a second mode, in which the relative displacement of the support bracket with respect to the fixing frame in the one direction is allowed to be greater than in the first mode, the damping member may be controlled to be switched from the first mode to the second mode based on that the displacement of the vehicle body frame in the one direction is greater than or equal to a first preset value, and the damping member may be controlled to be switched from the second mode to the first mode based on that a displacement of the support bracket with respect to the fixing frame in the one direction or an opposite direction to the one direction is greater than a second preset value due to the damping member and the damper may have a smaller damping coefficient in the second mode than in the first mode.

The fixing frame may include a first fixing frame that supports one side of the storage tank, and a second fixing frame extending parallel to the first fixing frame and that supports an opposite side of the storage tank, and the support bracket includes a first support bracket that supports the one side of the storage tank, and a second support bracket that supports the opposite side of the storage tank, and the damping member may include a first damping member that adjusts a relative movement of the first support bracket with respect to the first fixing frame in the one direction, and a second damping member that adjusts a relative movement of the second support bracket with respect to the second fixing frame in the one direction.

The storage tank fixing assembly may further include a controller that controls at least one of the first damping member and the second damping member based on that a difference between the displacement of the first vehicle body frame in the one direction and the displacement of the second vehicle body frame in the one direction is greater than or equal to a preset value.

The one direction may be an upward direction, and the controller may control the first damping member such that a relative movement of the first support bracket with respect to the first fixing frame in a vertical direction is allowed more freely based on that the displacement of the first vehicle body frame in the upward direction is greater than the displacement of the second vehicle body frame in the upward direction.

The storage tank fixing assembly may further include a guide bracket fixed to the fixing frame and that guides sliding of the support bracket in the one direction.

The guide bracket may include a sliding slot, into which the support bracket is inserted guiding the sliding of the support bracket in the one direction and extending in the one direction.

The support bracket may include a sliding part inserted into the sliding slot, and the guide bracket may include catching parts inserted into catching recesses formed on opposite surfaces of the sliding part.

The storage tank fixing assembly may further include a support frame coupled to the fixing frame, and a torsion bar coupled to the support bracket and the support frame.

The storage tank fixing assembly may further include a support frame coupled to the fixing frame, a bell crank coupled to the fixing frame, and a push rod connecting the bell crank and the support bracket, and the damping member may include one end coupled to the bell crank and an opposite end fixed to the support frame.

The support bracket may include a guide slot, into which the guide bracket is inserted guiding the sliding of the support bracket in the one direction and extending in the one direction.

The guide bracket may include a guide part inserted into the guide slot, and the support bracket may include locking parts inserted into locking recesses formed on opposite surfaces of the guide part.

The support bracket may be coupled to a band bracket having a band surrounding a body part of the storage tank.

According to an embodiment of the present disclosure, a method for controlling a storage tank fixing assembly including a first vehicle body frame and a second vehicle body frame provided in an interior of a vehicle, a storage tank, a first fixing frame and a second fixing frame connected to the first vehicle body frame and the second vehicle body frame, respectively, and extending in a vertical direction, a first support bracket that supports one side of the storage tank and a second support bracket that supports an opposite side of the storage tank, and a first damper that adjusts a movement of the first support bracket in the vertical direction and a second damper that adjusts a movement of the second support bracket in the upward/downward includes detecting a displacement of the first vehicle body frame or the second vehicle body frame, determining a difference between displacements of the first vehicle body frame and the second vehicle body frame in the vertical direction, determining whether the vehicle is in a harsh driving condition based on the difference between the displacements, identifying whether a displacement of the first vehicle body frame in a upward direction is greater than a displacement of the second vehicle body frame in the upward direction, based on that the difference between the displacements is greater than or equal to a first preset value, and performing a control to switch the first damper from a first mode to a second mode, in which a relative movement of the first support bracket with respect to the first fixing frame in the vertical direction is allowed more freely, based on that the displacement of the first vehicle body frame is greater than or equal to the displacement of the second vehicle body frame.

The preset value may be a first preset value, and the method may further include switching the first damper from the second mode to the first mode based on that the displacement of the first support bracket with respect to the fixing frame in the vertical direction is greater than or equal to a second preset value.

The method may further include identifying whether the displacement of the first fixing frame in the vertical direction is in a normal range, based on that the displacement of the first support bracket in the vertical direction is smaller than the second preset value.

The identifying of whether the displacement of the first fixing frame in the vertical direction is in a normal range may include identifying whether the displacement of the first fixing frame in the vertical direction is smaller than a third preset value.

As discussed, the method and system suitably include use of a controller or processer.

In another embodiment, vehicles are provided that comprise an apparatus as disclosed herein.

### BRIEF DESCRIPTION OF THE DRAWINGS

The above and other objects, features and advantages of the present disclosure will be more apparent from the following detailed description taken in conjunction with the accompanying drawings:

FIG. 1 is a front view of a hydrogen battery vehicle according to an embodiment of the present disclosure;

FIG. 2 is a view illustrating a storage tank, a first fixing frame, and a second fixing frame according to an embodiment of the present disclosure;

FIG. 3 is an enlarged view of portion “A” illustrated in FIG. 2;

FIG. 4 is a side cross-sectional view of portion “A” illustrated in FIG. 2;

FIG. 5 is an enlarged front view of a storage tank fixing assembly according to an embodiment of the present disclosure;

FIG. 6 is a view of portion “A” illustrated in FIG. 2, viewed from a bottom;

FIG. 7 is a cross-sectional view taken along line B-B′ illustrated in FIG. 6;

FIG. 8 is a view illustrating a storage tank, a first fixing frame, and a second fixing frame according to another embodiment of the present disclosure;

FIG. 9 is a side cross-sectional view of a storage tank fixing assembly according to another embodiment of the present disclosure;

FIG. 10 is a cross-sectional perspective view of a storage tank fixing assembly according to another embodiment of the present disclosure;

FIG. 11 is a schematic view illustrating a storage tank fixing assembly according to another embodiment of the present disclosure, viewed from a front side;

FIG. 12 is a cross-sectional view taken along line C-C′ illustrated in FIG. 11;

FIG. 13 is a schematic view illustrating a vehicle body frame and a connection frame according to an embodiment of the present disclosure, viewed from a lateral side;

FIG. 14 is a schematic view illustrating a vehicle body frame according to an embodiment of the present disclosure, viewed from a top;

FIGS. 15 and 16 are schematic views illustrating a storage tank, a position of which is changed by receiving a force from a vehicle body frame according to an embodiment of the present disclosure; and

FIG. 17 is a flowchart of a method for controlling a storage tank fixing assembly according to an embodiment of the present disclosure.

### DETAILED DESCRIPTION

Hereinafter, preferred embodiments of the present disclosure will be described in detail with reference to the attached drawings so that those skilled in the art may easily implement the present disclosure. The following description is one of several embodiments, and in describing one embodiment, detailed descriptions of known functions or configurations are omitted to clarify the gist of the present disclosure.

Furthermore, in describing the components of the embodiments of the present disclosure, terms, such as first, second, “A”, “B”, (a), and (b) may be used. The terms are simply for distinguishing the components, and the essence, the sequence, and the order of the corresponding components are not limited by the terms. Unless defined differently, all the terms including technical or scientific terms have the same meanings as those generally understood by an ordinary person in the art, to which the present disclosure pertains. The terms, such as the terms defined in dictionaries, which are generally used, should be construed to coincide with the context meanings of the related technologies, and are not construed as ideal or excessively formal meanings unless explicitly defined in the present disclosure.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

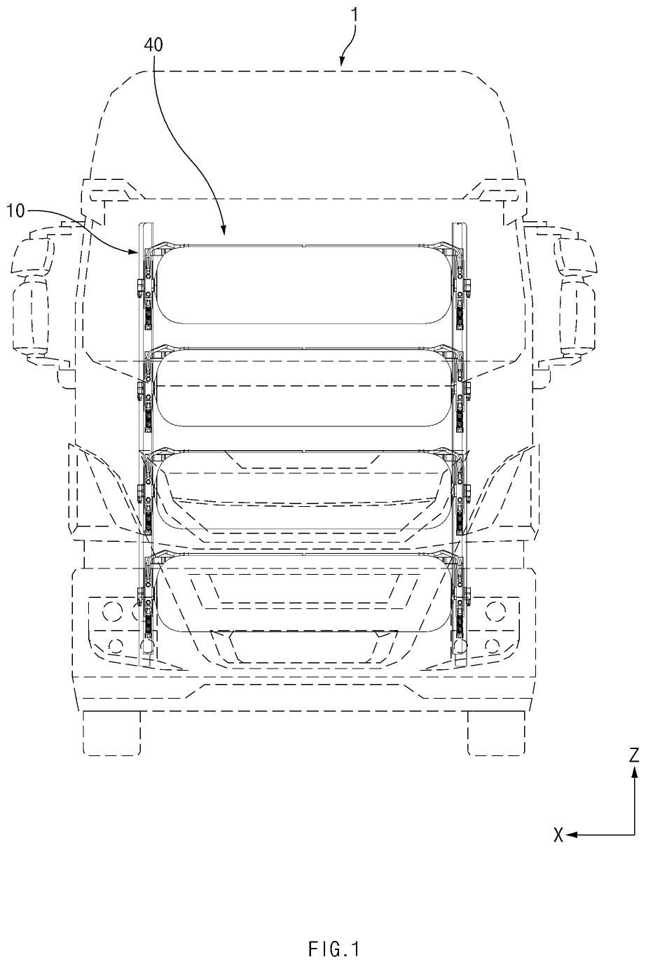

Hereinafter, embodiments of the present disclosure will be described in detail with reference to FIGS. 1 to 17.

FIG. 1 is a front view of a hydrogen battery vehicle 1 according to an embodiment of the present disclosure.

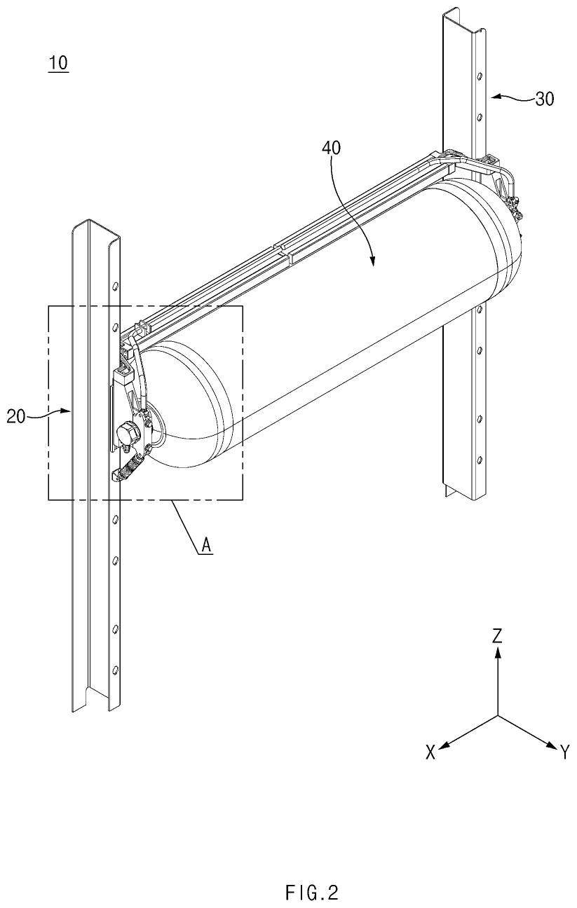

Referring to FIG. 1, the hydrogen battery vehicle 1 may have a vehicle frame and a plurality of wheels. The hydrogen battery vehicle 1 may include a storage tank fixing assembly (10) that supports a storage tank 40 (see FIG. 2) that extends in a widthwise direction (e.g., the “X” direction) of the vehicle in an interior thereof. The storage tank 40 may accommodate gas such as hydrogen.

Among hydrogen battery vehicles 1, large trucks have a higher body height from a road surface and are relatively heavier than small vehicles, and thus, more storage tanks 40 need to be installed in an interior of the vehicle. However, although the drawing illustrates a large truck, the right to present disclosure is not limited thereto.

In a large truck, a plurality of storage tanks 40 may be stacked in a height direction (e.g., the “Z” direction) of the vehicle body, and each storage tank 40 may be supported by a storage tank fixing assembly 10.

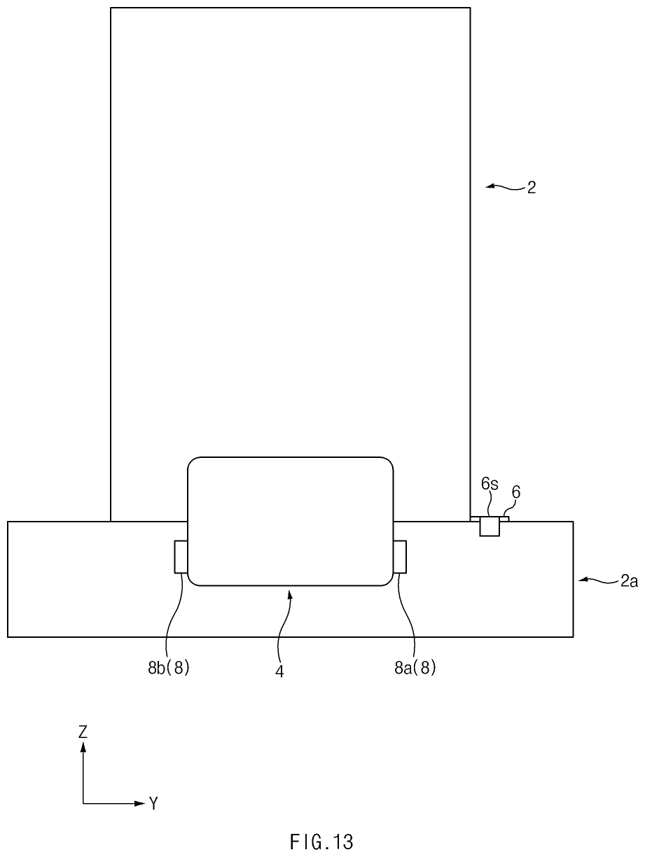

The storage tank 40 stacked in the height direction of the vehicle body is disposed at a high separation distance from the road surface, creating a risk of a damage due to vibrations from the road surface or twisting of vehicle body frames 2a and 3a (see FIG. 13).

Hereinafter, the storage tank fixing assembly 10 that may more stably support the storage tank 40 despite the vibration from the road surface or the twisting of the vehicle body frames 2a and 3a will be described in detail.

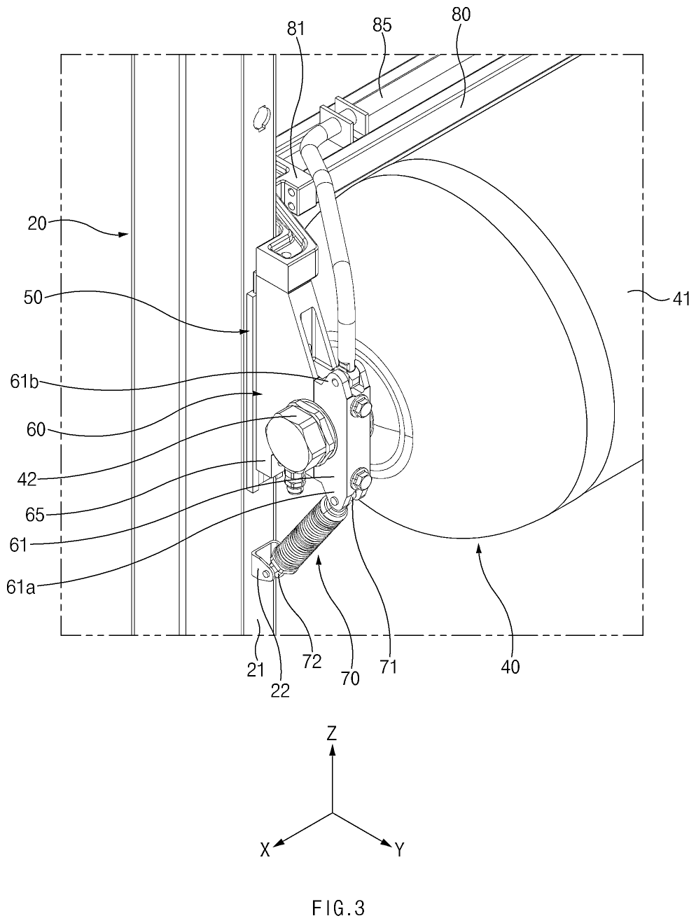

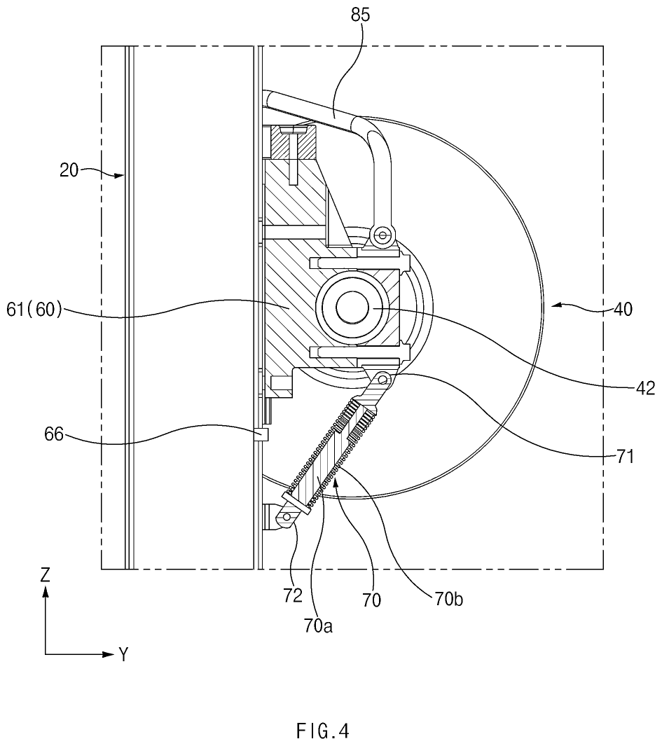

FIG. 2 is a view illustrating the storage tank 40, a first fixing frame 20, and a second fixing frame 30 according to an embodiment of the present disclosure. FIG. 3 is an enlarged view of portion “A” illustrated in FIG. 2. FIG. 4 is a side cross-sectional view of portion “A” illustrated in FIG. 2.

Referring to FIGS. 2 to 4, the storage tank fixing assembly 10 may include a first fixing frame 20 and a second fixing frame 30 that extend in parallel to each other in an upward direction (the “Z” direction).

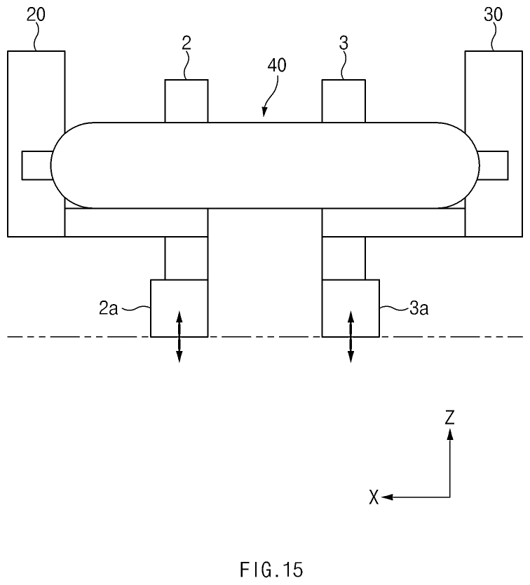

The first fixing frame 20 may support one side of the storage tank 40, and the second fixing frame 30 may support the other side of the storage tank 40. The first fixing frame 20 may be connected through a first connection frame 2 connected to the first vehicle body frame 2a, and the second fixing frame 30 may be connected through the second connection frame 3 connected to the second vehicle body frame 3a (see FIG. 15).

The first fixing frame 20 and the second fixing frame 30 may be displaced in a vertical direction in correspondence to displacements of the first vehicle body frame 2a and the second vehicle body frame 3a in the vertical direction, respectively.

The storage tank 40 may include a body part 41 and a nozzle part 42 in the width direction of the vehicle (e.g., the “X” direction). The body part 41 may have a cylindrical shape, and nozzle parts 42 may be disposed at opposite ends of the body part. The respective nozzle parts 42 may be coupled to a support bracket 60. The support bracket 60 may be configured to support the storage tank 40.

That is, the structure illustrated in FIGS. 2 to 7 may be a neck mounting structure, in which the opposite ends of the storage tank 40 are fixed by the support bracket 60.

The storage tank fixing assembly 10 according to an embodiment of the present disclosure may include a guide bracket 50 that is fixed to a fixing surface 21 of the first fixing frame 20. A position of the guide bracket 50 may be fixed to the fixing surface 21 of the first fixing frame 20 through a separate fastening member. The guide bracket 50 may guide sliding of the support bracket 60 in the vertical direction.

A sliding structure of the support bracket 60 with respect to the guide bracket 50 in the vertical direction will be described later.

The support bracket 60 may be configured to support the nozzle parts 42 of the storage tank 40, and a relative movement of the support bracket 60 with respect to the first fixing frame 20 in the vertical direction may be adjusted by the damping member 70.

That is, the support bracket 60 may be configured to support the storage tank 40 such that the storage tank 40 is slid with respect to the first fixing frame 20 in the upward direction (the “Z” direction) or the downward direction (the −Z direction).

The storage tank fixing assembly 10 may include a damping member 70 that adjusts a relative movement of the support bracket 60 with respect to the first fixing frame 20 in the upward direction (the “Z” direction) or the downward direction (the −Z direction).

The damping member 70 may include one end 71 that is connected to the support bracket 60 and an opposite end 72 that is connected to the first fixing frame 20 and may be configured to adjust a distance between the first fixing frame 20 and the support bracket 60.

The damping member 70 may include a damper 70a that is provided between the one end 71 and the opposite end 72 of the damping member 70, and a coil spring 70b that extends to surround the damper 70a.

The damper 70a may be provided as a hydraulic damper to adjust the damping coefficient, and the coil spring 70b may extend to surround the damper 70a to have the structure in which the elasticity range of the coil spring 70b is restricted by the damper 70a.

That is, because it may be difficult to adjust the separation distance between the first fixing frame 20 and the support bracket 60 with only the coil spring 70b, the damping member 70 may be provided as a spring damper, in which the coil spring 70b is coupled to the damper 70a so that the separation distance between the first fixing frame 20 and the support bracket 60 are adjusted more easily.

According to this principle, the support bracket 60 may be moved relative to the first fixing frame 20 in the vertical direction while a linear distance between the one end 71 and the opposite end 72 of the damping member 70 is adjusted.

The support bracket 60 may include a nozzle coupling part 61 that is coupled to the nozzle part 42 and a sliding part 65 that is inserted into the guide bracket 50. The nozzle coupling part 61 and the sliding part 65 may be combined as separate components, or may be provided integrally as one component. The nozzle coupling part 61 may be provided with a damping member fixing part 61a that is coupled to the one end 71 of the damping member 70, and a torsion bar fixing part 61b.

The storage tank fixing assembly 10 may include a support frame 80 that extends in a horizontal direction (e.g., the “X” direction) and connects the first fixing frame 20 and the second fixing frame 30. The support frame 80 may be coupled to the first fixing frame 20 and the second fixing frame 30, respectively to extend to be inclined in the horizontal direction when the first fixing frame 20 and the second fixing frame 30 are displaced in the vertical direction.

Because the structure of the storage tank fixing assembly 10 according to an embodiment of the present disclosure is a neck mounting structure, in which the nozzle parts 42 provided at the opposite ends of the storage tank 40 are supported, the twisting of the components located on the opposite sides of the storage tank 40 may be stronger than in a valley mounting structure that will be described later.

Correspondingly, the storage tank fixing assembly 10 may include a torsion bar 85 that is configured to alleviate the twisting of the components located on the opposite sides of the storage tank 40.

The torsion bar 85 may be coupled while extending along the support frame 80, and opposite ends thereof may be fixed to a torsion bar fixing part 61b of the support bracket 60. According to this structure, even when the positions of the first fixing frame 20 and the second fixing frame 30 in the vertical direction become different, and thus, even when the storage tank fixing assembly 10 is twisted, the influences of the twisting are reduced due to the torsion bar 85. This allows for a more stable support structure. The support frame 80 may be connected to the support bracket 60 through a link member 81.

As will be described later, a support bracket detecting sensor 66 may be provided on the fixing surface 21 of the first fixing frame 20. The support bracket detecting sensor 66 may detect whether the support bracket 60 is excessively displaced with respect to the first fixing frame 20 in the vertical direction. Furthermore, the position of the support bracket detecting sensor 66 is not limited thereto, and any sensor for detecting a relative displacement of the support bracket 60 with respect to the first fixing frame 20 in the upward or downward direction is sufficient.

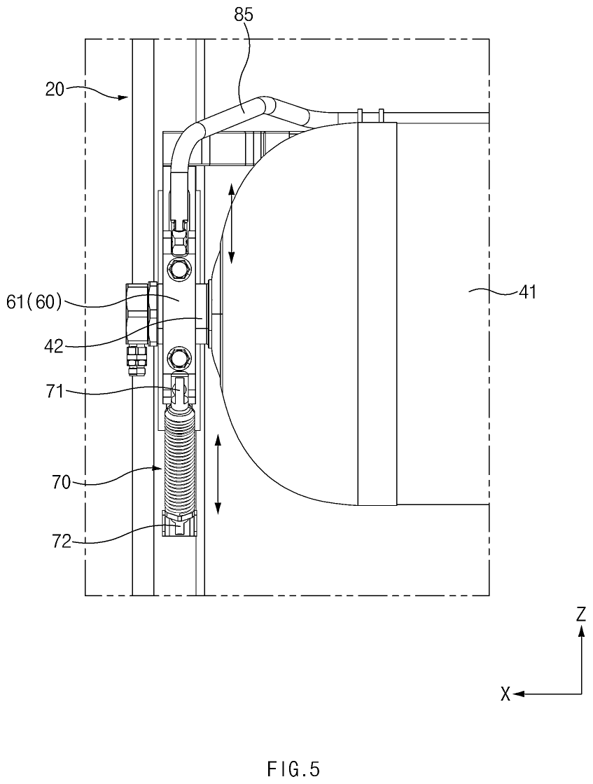

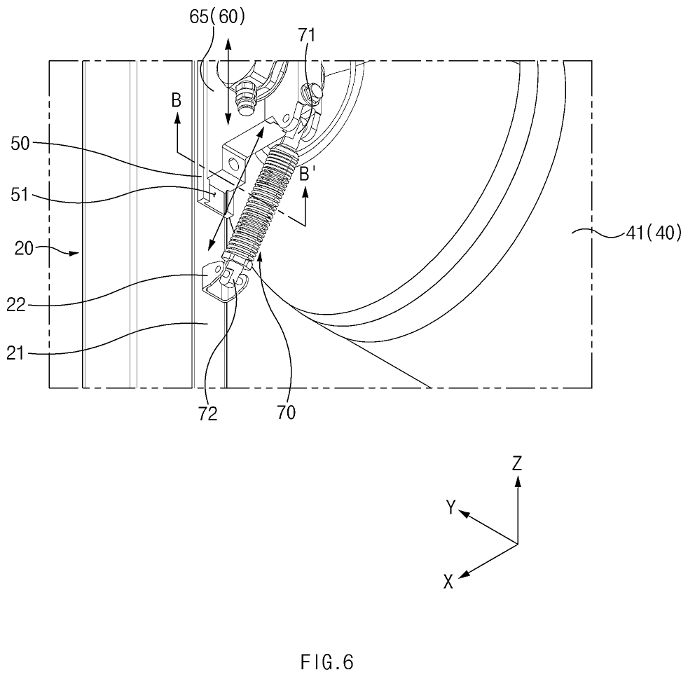

FIG. 5 is an enlarged front view of the storage tank fixing assembly 10 according to an embodiment of the present disclosure. FIG. 6 is a view illustrating portion “A” illustrated in FIG. 2, viewed from a bottom.

Referring to FIGS. 5 and 6, when the vehicle body frames 2a and 3a (see FIG. 15) are displaced from the road surface in the downward direction, the support bracket 60 is moved relative to the first fixing frame 20 in the upward direction, and the linear distance between the one end 71 and the opposite end 72 of the damping member 70 may increase and then decrease again, and thus, the support bracket 60 may be moved to become closer to its original position again. At the same time, the torsion bar 85 may also transmit a force to the support bracket 60 to prevent the support bracket 60 from being twisted.

On the other hand, even when the support bracket 60 moves relative to the first fixing frame 20 in the downward direction, the linear distance between the one end 71 and the opposite end 72 of the damping member 70 may increase and then decrease again, returning closer to its original position. At the same time, the torsion bar 85 may also receive a force from the support bracket 60 to prevent the support bracket 60 from being twisted.

According to this structure, even when the first fixing frame 20 or the second fixing frame 30 is displaced, the support bracket 60 and the storage tank 40 may not completely absorb vibration from the first fixing frame 20 or the second fixing frame 30 and vibrational energy may be partially converted to heat or frictional energy by the damping member 70 whereby a magnitude of vibration transmitted to the support bracket 60 may be relatively reduced.

That is, because the support bracket 60 receives relatively less vibration energy, the storage tank 40 may be supported more stably whereby the risk of damage to the storage tank 40 may be reduced. Furthermore, due to a more simplified structure, the weight of the storage tank fixing assembly 10 may be lowered and thus, economic efficiency may be improved.

Hereinafter, the sliding of the support bracket 60 on the guide bracket 50 in the vertical direction will be described.

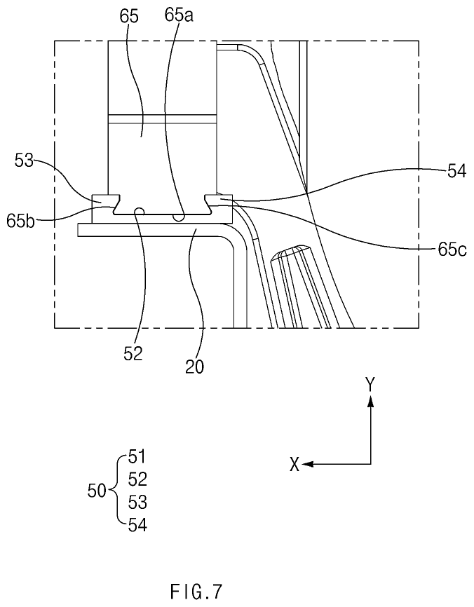

FIG. 7 is a cross-sectional view taken along line B-B′ illustrated in FIG. 6.

Referring to FIG. 7, the guide bracket 50 fixed to the first fixing frame 20 may include a sliding slot 51 (see FIG. 6), into which the sliding part 65 is inserted to guide the sliding of the support bracket 60 in the vertical direction and which extends in the vertical direction.

The sliding slot 51 may be formed on a side that faces the sliding part 65 and may extend in the vertical direction. The guide bracket 50 may include a slot surface 52 that faces the sliding part 65 and catching parts 53 and 54 that protruding toward each other to opposite sides of the slot surface 52.

The sliding part 65 may include a sliding surface 65a that contacts the slot surface 52 and catching recesses 65b and 65c that are formed on opposite surfaces that are located the opposite sides of the sliding surface 65a.

The catching recesses 65b and 65c may be formed on the opposite sides of the sliding part 65, which face opposite directions. Thus, the catching parts 53 and 54 of the guide bracket 50 may be inserted into them, respectively.

As the catching parts 53 and 54 are stopped by the catching recesses 65b and 65c, the movement of the sliding part 65 in a vertical direction in the vertical direction may be restricted, and the sliding part 65 may be only slid with respect to the guide bracket 50 in the vertical direction.

Accordingly, the support bracket 60 of the storage tank fixing assembly 10 may be moved relative to the first fixing frame 20 in the vertical direction.

Meanwhile, the guide bracket 50, the support bracket 60, the nozzle part 42, and the damping member 70 described above are the first guide bracket 50, the first support bracket 60, the first nozzle part 42, and the first damping member 70, respectively, and correspondingly, the second guide bracket, the second support bracket, the second nozzle part, and the second damping member are disposed adjacent to the second fixing frame 30 whereby the relative movement of the support bracket 60 with respect to the second fixing frame 30 in the vertical direction may be adjusted.

Furthermore, the present disclosure is not limited thereto, and the guide bracket 50 is not provided as a separate configuration from the fixing frames 20 and 30, and the slot surface 52 and the catching parts 53 and 54 that protrude from the slot surface 52 may be formed integrally with the fixing frames 20 and 30 on one surface that faces the sliding part 65.

Accordingly, the storage tank fixing assembly 10 may be supported more stably even when the vehicle body frames 2a and 3a (see FIG. 13) are twisted.

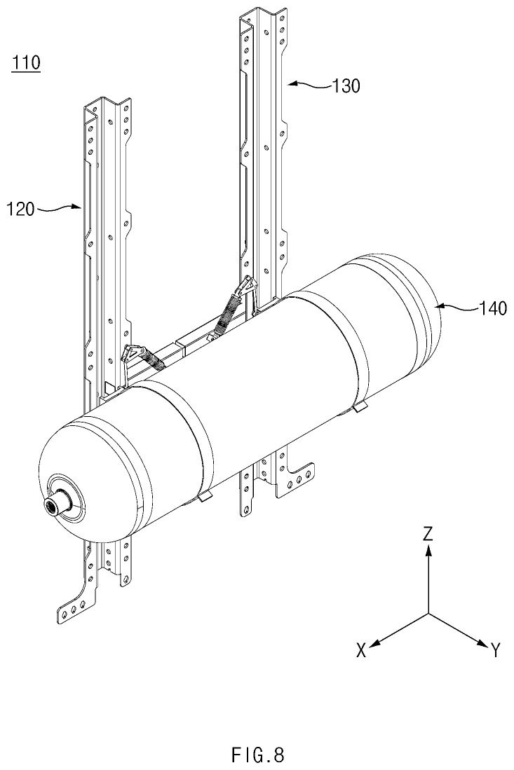

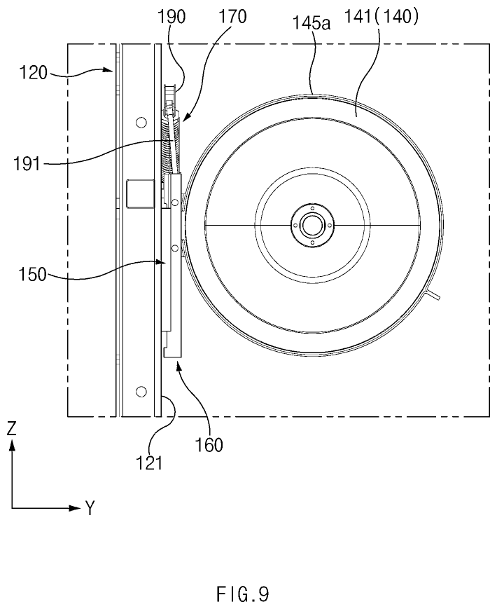

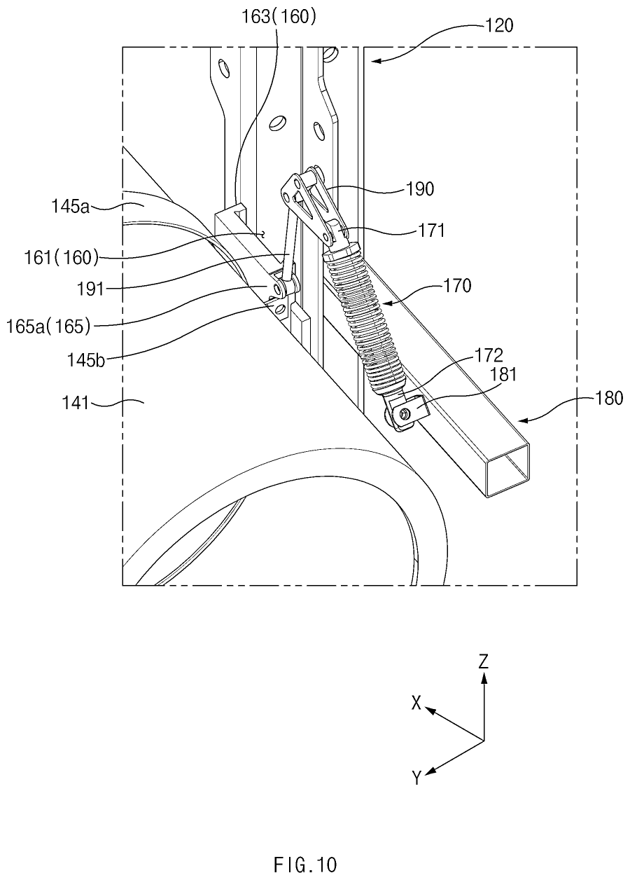

FIG. 8 is a view illustrating a storage tank 140, a first fixing frame 120, and a second fixing frame 130 according to another embodiment of the present disclosure. FIG. 9 is a side cross-sectional view of a storage tank fixing assembly 110 according to another embodiment of the present disclosure. FIG. 10 is a cross-sectional perspective view of the storage tank fixing assembly 110 according to another embodiment of the present disclosure.

Referring to FIGS. 8 to 10, the storage tank fixing assembly 110 may include the first fixing frame 120 and a second fixing frame 130 that extend in the upward direction (the “Z” direction) in parallel to each other.

The first fixing frame 120 may support the one side of the storage tank 140, and the second fixing frame 130 may support the opposite side of the storage tank 40. The first fixing frame 120 may be connected to the first vehicle body frame 2a (see FIG. 15), and the second fixing frame 30 may be connected to the second vehicle body frame 3a.

The storage tank fixing assembly 110 according to another embodiment of the present disclosure a valley mounting structure, in which the storage tank 140 is supported through a band 145a that surrounds the opposite sides of the body part 141 of the storage tank 140. Unlike the neck mounting structure described above, the valley mounting structure may support the opposite sides of the body part 141 of the storage tank 140 and may be supported by the support bracket 160 through a band bracket 145b having a band 145a.

The storage tank fixing assembly 110 may include a guide bracket 150 that is coupled to the fixing surface 121 of the first fixing frame 120 that extends in the vertical direction, and a support bracket 160 that is slid in the vertical direction with respect to the guide bracket 150.

As will be described later, the support bracket 160 may include a guide slot 161 that is formed on one side that faces the first fixing frame 120 and into which the guide bracket 150 is inserted.

The support bracket 160 may be moved relative to the first fixing frame 120 in the vertical direction. In other words, the storage tank fixing assembly 110 may further include a damping member 170 that is configured to adjust a relative movement of the support bracket 160 with respect to the first fixing frame 120 in the vertical direction.

The storage tank fixing assembly 110 may include a support frame 180 that is coupled to the first fixing frame 120 and the second fixing frame 130 and extends from the first fixing frame 120 toward the second fixing frame 130. Unlike the illustration of the drawing, the damping member 170 may be configured to connect the support bracket 160 and the first fixing frame 120, but the storage tank 40 illustrated in FIG. 1 may be stacked in the height direction of the vehicle body whereby the damping member 170 is coupled to a bell crank 190 to avoid interference with the adjacent storage tank 40 and thus, a relative movement of the support bracket 160 relative to the first fixing frame 120 in the/downward direction may be adjusted.

The bell crank 190 may be coupled to the first fixing frame 120 and may be connected to the support bracket 160 through a push rod 191 that connects the bell crank 190 and the support bracket 160. Furthermore, the damping member 170 may include one end 171 that is coupled to the bell crank 190 and an opposite end 172 that is fixed to the support frame 180 through a damping member bracket 181. The damping member 170 may correspond to the structure of the damping member 70 described above.

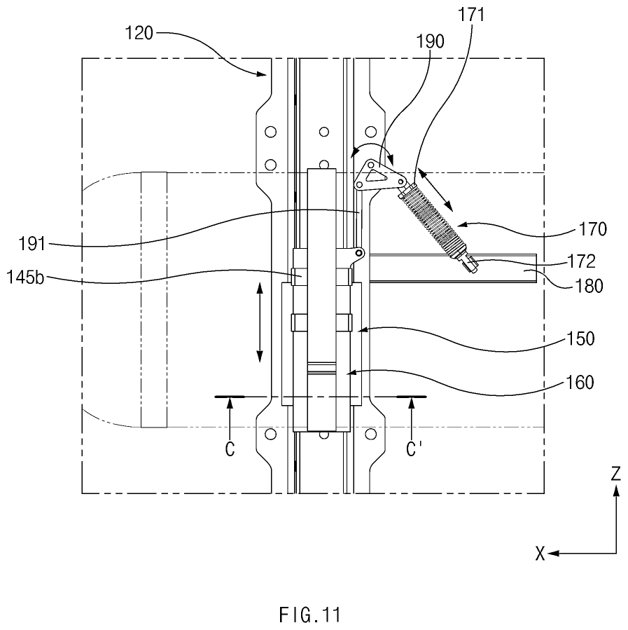

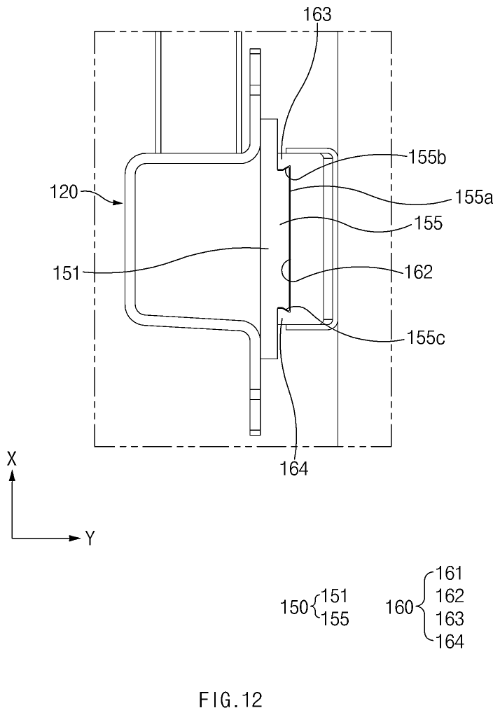

The bell crank 190 may rotate the one end 171 of the damping member 170 while receiving the relative movement of the support bracket 160 with respect to the first fixing frame 120 in the vertical direction through the push rod 191 and rotating. A more detailed structure thereof will be described with reference to FIGS. 11 and 12.

FIG. 11 is a schematic view illustrated from the front of the storage tank fixing assembly 110 according to another embodiment of the present disclosure. FIG. 12 is a cross-sectional view taken along line C-C′ illustrated in FIG. 11.

Referring to FIGS. 11 and 12, when the vehicle body frames 2a and 3a (see FIG. 15) are displaced from the road surface in the downward direction, the support bracket 160 may be moved upward relative to the first fixing frame 120, and the bell crank 190 may be rotated clockwise by the push rod 191 whereby the linear distance between the opposite end 172 fixed to the support frame 180 and the bell crank 190 may decrease and increase again so that the support bracket 160 may be moved to become closer to its original position again.

On the other hand, even when the support bracket 160 is moved relative to the first fixing frame 120 in the downward direction, the bell crank 190 may be rotated counterclockwise while the push rod 191 pulls the bell crank 190 in the downward direction. When the bell crank 190 is rotated, the support bracket 160 may be moved to its original position again while a minimum distance between the one end 171 of the damping member 170 coupled to the bell crank 190 and the opposite end 172 fixed to the support frame 180 may increase and then decrease again

According to this structure, because the support bracket 160 and the storage tank 140 do not completely absorb the vibration from the vehicle body frames 2a and 3a by the bell crank 190 and the push rod 191, but the damping member 170 partially absorbs the vibration energy and then transfers it to the support bracket 160, the influence of the vibration received by the support bracket 160 may be relatively reduced.

For this structure, the support bracket 160 has to be able to be slid with respect to the guide bracket 150 in the vertical direction, and for this, the support bracket 160 may include a guide slot 161, into which the guide bracket 150 is inserted to guide the sliding of the support bracket 160 in the vertical direction and that extends in the vertical direction.

The support bracket 160 may include a guide surface 162 that faces the guide bracket 150, and locking parts 163 and 164 that are provided on opposite sides of the guide surface 162 and protrude toward each other.

The guide bracket 150 may include a fixing frame coupling part 151 and a guide part 155 for insertion into the guide slot 161. The guide part 155 may include a contact surface 165a that faces the guide surface 162, and locking recesses 155b and 155c that are formed on opposite sides of the guide part 155 located on the opposite sides of the contact surface 165a.

The locking recesses 155b and 155c may be formed on the opposite sides of the guide part 155, which face opposite directions so that the locking parts 163 and 164 of the support bracket 160 may be inserted thereinto, respectively.

As the locking parts 163 and 164 are inserted into the locking recesses 155b and 155c, the movement of the support bracket 160 in the vertical direction in the vertical direction along the guide part 155 may be restricted, and the support bracket 160 may be slid with respect to the guide part 155 only in the vertical direction.

In this way, the support bracket 160 of the storage tank fixing assembly 110 may be moved with respect to the first fixing frame 120 in the vertical direction.

Meanwhile, the guide bracket 150, the support bracket 160, and the damping member 170 described above may be the first guide bracket 150, the first support bracket 160, and the first damping member 170, respectively, and correspondingly, A second guide bracket, a second support bracket, and a second damping member may be disposed adjacent to the second guide bracket, to adjust a relative movement of the second support bracket with respect to the second fixing frame 130 in the vertical direction. Furthermore, the storage tank fixing assembly 110 may be supported more stably even when the vehicle body frames 2a and 3a (see FIG. 15) are twisted.

Furthermore, the present disclosure is not limited thereto, and the fixing frames 120 and 130 and the support bracket 160 are not provided as separate components, but the guide part 155 that protrude in a direction facing the support bracket 160 with respect to the fixing frames 120 and 130 may be formed integrally with the fixing frame 120 and 130.

Furthermore, unlike the structure described above, the protrusions of the support bracket 160 and the recesses of the fixing frames 120 and 130 are coupled to each other so that the support bracket 160 may be moved with respect to the fixing frames 120 and 130 in the vertical direction (the “Z” direction).

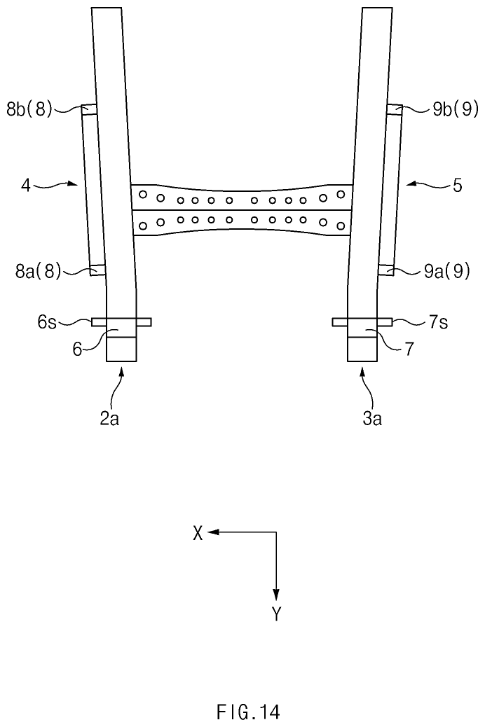

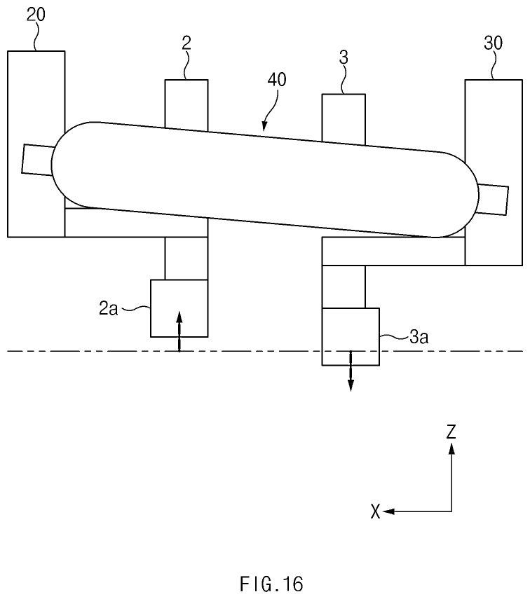

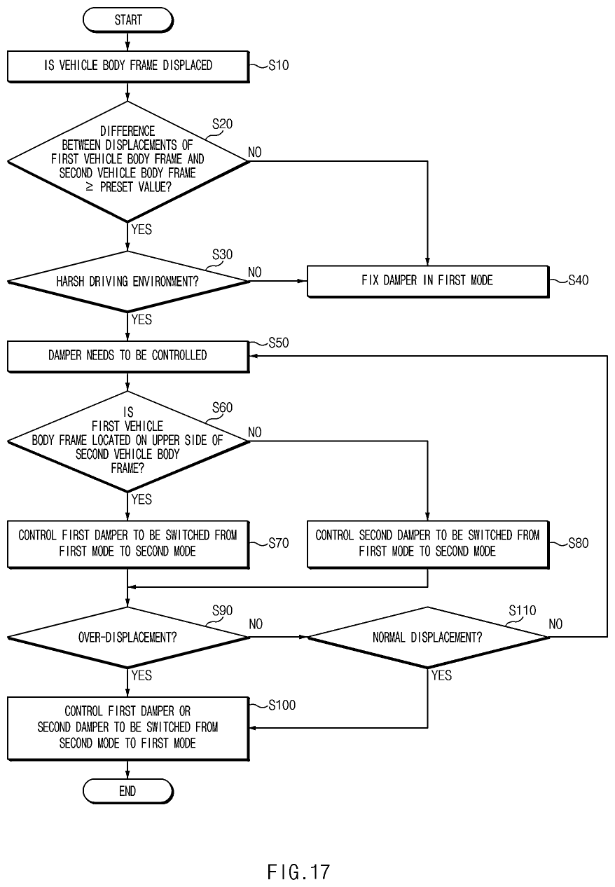

FIG. 13 is a schematic view illustrating the vehicle body frames 2a and 3a and the connection frames 2 and 3 according to an embodiment of the present disclosure, viewed from a lateral side. FIG. 14 is a schematic view illustrating the vehicle body frames 2a and 3a according to an embodiment of the present disclosure, viewed from a top. FIGS. 15 and 16 are schematic views illustrating the storage tank 40, a position of which is changed by receiving a force from the vehicle body frames 2a and 3a according to an embodiment of the present disclosure. FIG. 17 is a flowchart of a method for controlling the storage tank fixing assembly 10 according to an embodiment of the present disclosure.

Hereinafter, it is assumed that the storage tank fixing assembly 10 of FIG. 2 performs a process of FIG. 17. However, correspondingly, the storage tank fixing assembly 110 of FIG. 8 may perform the process of FIG. 17. Furthermore, in a description of FIG. 17, the operation described as being performed by the apparatus may be understood as being controlled by a controller (not illustrated) of the storage tank fixing assembly.

Referring to FIGS. 13 to 17, the vehicle body frames 2a and 3a may be frames that extend horizontally toward a forward direction (e.g., in the “Y” direction) from the road surface. The vehicle body frames 2a and 3a may be provided with the connection frames 2 and 3 that extend in a direction perpendicular to the vehicle body frames 2a and 3a.

The vehicle body frames 2a and 3a may include the first vehicle body frame 2a and the second vehicle body frame 3a, and the connection frames 2 and 3 may include the first connection frame 2 that is coupled to the first vehicle body frame 2a and the second connection frame 3 that is coupled to the second vehicle body frame 3a.

The first connection frame 2 may be coupled to the first vehicle body frame 2a by the first support frame 4, and the second connection frame 3 may be coupled to the second vehicle body frame 3a by the second support frame 5.

The first fixing frame 20 and the second fixing frame 30 may be connected to the first vehicle body frame 2a and the second vehicle body frame 3a, respectively, to be displaced in the vertical direction.

In a hydrogen battery vehicle, the displacement of the vehicle body frames 2a and 3a in the vertical direction from a reference line may not be relatively large.

However, as illustrated in FIG. 15, in the hydrogen battery vehicle, the displacement of the vehicle body frames 2a and 3a in the vertical direction from the reference line may be relatively large.

Then, displacement detecting sensors 6 and 7, which are configured to detect displacement of the vehicle body frames 2a and 3a in the vertical direction, may be attached to the vehicle body frames 2a and 3a.

In more detail, the first displacement detecting sensor 6 may be attached to the first vehicle body frame 2a by a first sensor coupling part 6s, and the second displacement detecting sensor 7 may be attached to the second vehicle body frame 3a by the second sensor coupling part 7s.

The first displacement detecting sensor 6 and the second displacement detecting sensor 7 may be configured to detect displacement of the first vehicle body frame 2a and the second vehicle body frame 3a in the vertical direction, respectively.

Furthermore, the first support frame 4 may be provided with a first acceleration detecting sensor 8 that is configured to detect an acceleration of the first vehicle body frame 2a, and the second support frame 5 may be provided with a second acceleration detecting sensor 9 that is configured to detect an acceleration of the second vehicle body frame 3a.

In more detail, a first front acceleration detecting sensor 8a may be provided on a front surface of the first support frame 4, and a first rear acceleration detecting sensor 8b may be provided on a rear surface of the first support frame 4. Furthermore, a second front acceleration detecting sensor 9a may be provided on a front surface of the second support frame 5, and a second rear acceleration detecting sensor 9b may be provided on a rear surface of the second support frame 5.

The acceleration detecting sensors 8 and 9 may be sensors for determining whether a driving condition of the hydrogen battery vehicle 1 (see FIG. 1) is a harsh environment or a twisting state simply due to an inclination by detecting accelerations of the first vehicle body frame 2a and the second vehicle body frame 3a in the vertical direction.

Due to this structure, the displacement of the first vehicle body frame 2a or the second vehicle body frame 3a in the vertical direction may be detected by the displacement detecting sensors 6 and 7. Meanwhile, based on that the difference between the displacements of the first vehicle body frame 2a and the second vehicle body frame 3a in the vertical direction is greater than or equal to a first preset value, the damping member 70 may be controlled, by the controller, such that a relative movement of at least one of the first support bracket 60 and the second support bracket with respect to the first fixing frame 20 or the second fixing frame 30 in the vertical direction is allowed more freely.

That is, the damping member 70 may be switched between a first mode and the second mode, in which a greater relative displacement of the support bracket 60 with respect to the adjacent fixing frames 20 and 30 in the vertical direction is allowed.

That is, the damping member 70 may be controlled to be switched between the first mode and the second mode. When the relative movements of the support bracket 60 with respect to the adjacent fixing frames 20 and, 30 in the vertical direction according to the displacements of the vehicle body frames 2a and 3a are the same, the first fixing frame 20 and the second fixing frame 30, and the first support bracket 60 and the second support bracket may be moved together with the storage tank 40 like a rigid body, and damage to parts may become more severe due to collisions between parts, such as the first support bracket 60, the second support bracket, and the storage tank 40.

On the other hand, in the structure according to an embodiment of the present disclosure, the first mode, in which the displacements of the vehicle body frames 2a and 3a in the vertical direction is relatively small, may be switched to the second mode to allow a larger relative displacement with respect to the adjacent fixing frames 20 and 30 of the support bracket 60 in the vertical direction based on that the displacement of the first fixing frame 20 or the second fixing frame 30 in the vertical direction is greater than or equal to a first preset value. Accordingly, an impact between the support bracket 60 and the adjacent components may be prevented in advance whereby durability may be improved and a safety accident may be prevented.

Furthermore, the damping member 70 may be controlled to be switched from the second mode to the first mode by identifying that the displacement of the support bracket 60 with respect to the first fixing frame 20 or the second fixing frame 30 in the vertical direction becomes greater than expected by the damping member 70 in the second mode. In this way, after the relative movement of the support bracket 60 in the vertical direction is controlled to some extent, the relative movement with respect to the fixing frames 20 and 30 may be reduced again whereby a support structure of the storage tank 40 and the support bracket 60 may be implemented more stably.

In more detail, when the hydrogen battery vehicle starts driving, the vehicle body frames 2a and 3a may be displaced depending on the driving condition (S10).

The controller may determine whether the difference between the displacements of the first vehicle body frame 2a and the second vehicle body frame 3a in the vertical direction is greater than or equal to the first preset value (S20). The displacement then may be determined by electrical signals from the displacement detecting sensors 6 and 7 provided adjacent to the vehicle body frames 2a and 3a.

When the difference between the displacements of the first vehicle body frame 2a and the second vehicle body frame 3a in the vertical direction is smaller than the first preset value (No in S20), the damper 70a is fixed in the first mode. That is, the damper 70a is not controlled separately, and may be controlled to have a first damping coefficient in the first mode. Here, the first preset value may be 200 mm.

When the difference between the displacements of the first vehicle body frame 2a and the second vehicle body frame 3a in the vertical direction is greater than or equal to the first preset value (Yes in S20), the controller may determine whether the hydrogen battery vehicle is in a ‘harsh driving condition’ (S30).

It may be determined whether the hydrogen battery vehicle is in a ‘harsh driving condition’, by receiving an electrical signal from the acceleration detecting sensors 8 and 9 provided adjacent to the vehicle body frames 2a and 3a. As an example, it may be determined depending on electrical signals of the first front acceleration detecting sensor 8a and the first rear acceleration detecting sensor 8b that are adjacent to the first vehicle body frame 2a and the second front acceleration detecting sensor 9a and the second rear acceleration detecting sensor 9b that are adjacent to the second vehicle body frame 3a.

When the magnitude of the acceleration detected by the first front acceleration detecting sensor 8a, the first rear acceleration detecting sensor 8b, the second front acceleration detecting sensor 9a, or the second rear acceleration detecting sensor 9b is greater than or equal to approximately 4.6 times of the gravitational acceleration, it may be determined as a ‘harsh driving condition’ (Yes in S30). On the other hand, when it is smaller than that, it is determined as a ‘normal driving condition’ due to a simple inclination or a high-speed bump (No in S30), and thus the damper 70a in the first mode may not be separately controlled to be fixed.

when the hydrogen battery vehicle is determined to be in a ‘harsh driving condition’ (Yes in S30), the controller may recognize a need to control the damper 70a (S50).

Thereafter, the controller may select, among the first fixing frame 20 and the second fixing frame 30, the fixing frame located on an upper side (S60), and may allow the relative movement of the support bracket 60 with respect to the fixing frames 20 and 30 more freely.

In other words, when the first vehicle body frame 2a is located on an upper side of the second vehicle body frame 3a by comparing the displacement of the first vehicle body frame 2a in the upward direction with the displacement of the second vehicle body frame 3a in the upward direction (Yes in S60), the first damper 70a may be switched from the first mode to the second mode (S70) whereby the relative movement of the first support bracket 60 with respect to the first fixing frame 20 in the vertical direction is allowed more freely.

Then, the damping coefficient of the first damper 70a may be controlled to a second damping coefficient that is smaller than the first damping coefficient in the first mode.

On the other hand, when the second vehicle body frame 3a is located on an upper side of the first vehicle body frame 2a (No in S60), the second damper may be switched from the first mode to the second mode (S80) whereby the relative movement of the second support bracket with respect to the second fixing frame 30 becomes freer.

Thereafter, after the mode of the first damper 70a or the second damper is switched from the first mode to the second mode, the controller may determine whether an over-displacement occurs (S90).

In more detail, the support bracket detecting sensor 66 (see FIG. 4) may detect that the support bracket 60 deviates from a specific displacement relative to the fixing frames 20 and 30 in the upward or downward direction, and when the support bracket detecting sensor 66 detects the support bracket 60, it may be identified that the support bracket 60 is over-displaced.

That is, the first damping member 70 may be switched from the second mode to the first mode again based on that the displacement of the support bracket 60 with respect to the first fixing frame 20 in the vertical direction is greater than or equal to the second preset value (S100).

In other words, when an over-displacement of the support bracket 60 is identified, the controller allows the support bracket 60 to be excessively free due to the first damper 70a or the second damper whereby the second mode of the first damper 70a or the second damper may be controlled to be switched to the first mode again (S100). That is, the damping coefficient of the first damper 70a or the second damper may be controlled to be larger when the second mode is switched to the first mode again.

On the other hand, when the support bracket 60 is not over-displaced (S90), the controller may determine whether the first fixing frame 20 or the second fixing frame 30 is normally displaced (S110).

Based on that the displacement of the support bracket 60 with respect to the first fixing frame 20 in the vertical direction is smaller than the second preset value (No in S90), it may be determined whether the displacement of the first fixing frame 20 or the second fixing frame 30 in the vertical direction is within the normal displacement (S110).

When the displacement of the first fixing frame 20 or the second fixing frame 30 in the vertical direction is not the normal displacement (No in S110), the controller may recognize a need to control the damper 70a again (S50).

As an example, when the displacement of the first fixing frame 20 or the second fixing frame 30 in the vertical direction is smaller than a third preset value, that is, the displacement of the first fixing frame 20 or the second fixing frame 30 in the vertical direction is the normal displacement (Yes in S110), the controller may control the first damper 70a or the second damper such that the second mode of the first damper 70a or the second damper is switched to the first mode (S100).

Meanwhile, the controller may include at least one processor, a memory, a user interface input device, a user interface output device, a storage, and a network interface.

The processor may be a central processing unit (CPU) or a semiconductor device that executes processing on instructions stored in the memory and/or the storage. The memory and the storage may include various types of volatile or non-volatile storage media. For example, the memory may include a read only memory (ROM) and a random access memory (RAM).

Accordingly, the operations of the method or algorithm described in connection with the embodiments disclosed herein may be implemented directly as hardware, software modules, or a combination of the two, which is executed by the processor. The software modules may reside in a storage medium (i.e., the memory and/or the storage), such as a RAM memory, a flash memory, a ROM memory, an EPROM memory, an EEPROM memory, registers, a hard disk, a detachable disk, or a CD-ROM.

An exemplary storage medium may be coupled to a processor, the processor may read information from and write information to the storage medium. Alternatively, the storage medium may be integral with the processor. The processor and the storage medium may reside within an application specific integrated circuit (ASIC). The ASIC may reside in a user terminal. Alternatively, the processor and the storage medium may reside as separate components in the user terminal.

This technology may adjust the degree of freedom of the fixing frames of the storage tank depending on the situation, thereby alleviating the load on the fixing frames. As a result, the storage tank can be supported more stably, even while driving.

In addition, this technology may prevent safety accidents because the storage tank may be supported more stably.

In addition, various effects that can be directly or indirectly recognized through this document may be provided.

The above description is a simple exemplary description of the technical spirits of the present disclosure, and an ordinary person in the art, to which the present disclosure pertains, may make various corrections and modifications without departing from the essential characteristics of the present disclosure.

Therefore, the embodiments disclosed in the present disclosure are not for limiting the technical spirits of the present disclosure but for describing them, and the scope of the technical spirits of the present disclosure is not limited by the embodiments. The protection scope of the present disclosure should be construed by the following claims, and all the technical spirits in the equivalent range should be construed as being included in the scope of the present disclosure.

What is claimed is:

1. A storage tank fixing assembly comprising:
a fixing frame connected to a vehicle body frame and extending in one direction;
a support bracket configured to support a storage tank such that the storage tank is slid in the one direction with respect to the fixing frame; and
a damping member configured to adjust a relative movement of the support bracket with respect to the fixing frame in the one direction.

2. The storage tank fixing assembly of claim 1, wherein the damping member is configured to allow the relative movement of the support bracket with respect to the fixing frame in the one direction more freely based on that a displacement of the vehicle body frame in the one direction is greater than or equal to a preset value.

3. The storage tank fixing assembly of claim 1, wherein the damping member comprises:
a damper provided between one end connected to the fixing frame and an opposite end connected to the support bracket; and
a coil spring extending to surround the damper.

4. The storage tank fixing assembly of claim 2, further comprising:
a displacement detecting sensor configured to detect the displacement of the vehicle body frame in the one direction.

5. The storage tank fixing assembly of claim 3, wherein the damping member comprises a first mode, and a second mode, in which the relative displacement of the support bracket with respect to the fixing frame in the one direction is allowed to be greater than in the first mode,
wherein the damping member is controlled to be switched from the first mode to the second mode based on that the displacement of the vehicle body frame in the one direction is greater than or equal to a first preset value,
wherein the damping member is controlled to be switched from the second mode to the first mode based on that a displacement of the support bracket with respect to the fixing frame in the one direction or an opposite direction to the one direction is greater than a second preset value due to the damping member, and
wherein the damper has a smaller damping coefficient in the second mode than in the first mode.

6. The storage tank fixing assembly of claim 1, wherein the fixing frame comprises a first fixing frame configured to support one side of the storage tank, and a second fixing frame extending parallel to the first fixing frame and configured to support an opposite side of the storage tank,
wherein the support bracket comprises a first support bracket configured to support the one side of the storage tank, and a second support bracket configured to support the opposite side of the storage tank, and
wherein the damping member comprises a first damping member configured to adjust a relative movement of the first support bracket with respect to the first fixing frame in the one direction, and a second damping member configured to adjust a relative movement of the second support bracket with respect to the second fixing frame in the one direction.

7. The storage tank fixing assembly of claim 6, further comprising:
a controller configured to control at least one of the first damping member and the second damping member based on that a difference between the displacement of the first vehicle body frame in the one direction and the displacement of the second vehicle body frame in the one direction is greater than or equal to a preset value.

8. The storage tank fixing assembly of claim 7, wherein the one direction is an upward direction, and
wherein the controller controls the first damping member such that a relative movement of the first support bracket with respect to the first fixing frame in a vertical direction is allowed more freely based on that the displacement of the first vehicle body frame in the upward direction is greater than the displacement of the second vehicle body frame in the upward direction.

9. The storage tank fixing assembly of claim 1, further comprising:
a guide bracket fixed to the fixing frame and configured to guide sliding of the support bracket in the one direction.

10. The storage tank fixing assembly of claim 9, wherein the guide bracket comprises a sliding slot into which the support bracket is inserted, guiding the sliding of the support bracket in the one direction and extending in the one direction.

11. The storage tank fixing assembly of claim 10, wherein the support bracket comprises a sliding part inserted into the sliding slot, and
wherein the guide bracket comprises catching parts inserted into catching recesses formed on opposite surfaces of the sliding part.

12. The storage tank fixing assembly of claim 1, further comprising:
a support frame coupled to the fixing frame; and
a torsion bar coupled to the support bracket and the support frame.

13. The storage tank fixing assembly of claim 1, further comprising:
a support frame coupled to the fixing frame;
a bell crank coupled to the fixing frame; and
a push rod connecting the bell crank and the support bracket,
wherein the damping member comprises one end coupled to the bell crank and an opposite end fixed to the support frame.

14. The storage tank fixing assembly of claim 13, wherein the support bracket comprises a guide slot into which the guide bracket is inserted, guiding the sliding of the support bracket in the one direction and extending in the one direction.

15. The storage tank fixing assembly of claim 14, wherein the guide bracket comprises a guide part inserted into the guide slot, and
wherein the support bracket comprises locking parts inserted into locking recesses formed on opposite surfaces of the guide part.

16. The storage tank fixing assembly of claim 13, wherein the support bracket is coupled to a band bracket having a band surrounding a body part of the storage tank.

17. A method for controlling a storage tank fixing assembly comprising a first vehicle body frame and a second vehicle body frame provided in an interior of a vehicle, a storage tank, a first fixing frame and a second fixing frame connected to the first vehicle body frame and the second vehicle body frame, respectively, and extending in a vertical direction, a first support bracket configured to support one side of the storage tank and a second support bracket configured to support an opposite side of the storage tank, and a first damper configured to adjust a movement of the first support bracket in the vertical direction and a second damper configured to adjust a movement of the second support bracket in the upward/downward, the method comprising:
detecting a displacement of the first vehicle body frame or the second vehicle body frame;
determining a difference between displacements of the first vehicle body frame and the second vehicle body frame in the vertical direction;
determining whether the vehicle is in a harsh driving condition based on the difference between the displacements;
identifying whether a displacement of the first vehicle body frame in a upward direction is greater than a displacement of the second vehicle body frame in the upward direction, based on that the difference between the displacements is greater than or equal to a first preset value; and
performing a control to switch the first damper from a first mode to a second mode, in which a relative movement of the first support bracket with respect to the first fixing frame in the vertical direction is allowed more freely, based on that the displacement of the first vehicle body frame is greater than or equal to the displacement of the second vehicle body frame.

18. The method of claim 17,
wherein the method further comprises switching the first damper from the second mode to the first mode based on that the displacement of the first support bracket with respect to the fixing frame in the vertical direction is greater than or equal to a second preset value.

19. The method of claim 18, further comprising:
identifying whether the displacement of the first fixing frame in the vertical direction is in a normal range, based on that the displacement of the first support bracket in the vertical direction is smaller than the second preset value.

20. The method of claim 19, wherein the identifying of whether the displacement of the first fixing frame in the vertical direction is in a normal range comprises:
identifying whether the displacement of the first fixing frame in the vertical direction is smaller than a third preset value.
